(19) United States
(12) Patent Application Publication
(10) Pub. No.: US 2025/0102703 A1
(43) Pub. Date: Mar. 27, 2025

(54) TROPICAL STORM FORECASTING SYSTEM AND METHODS

(71) Applicant: DTN, LLC, Elkhorn, NE (US)

(72) Inventors: SAMUEL LILLO, Westminster, CO (US); Floris Bijlsma, Wageningen (NL)

(21) Appl. No.: 18/761,175

(22) Filed: Jul. 1, 2024

Related U.S. Application Data
(60) Provisional application No. 63/524,509, filed on Jun. 30, 2023.

(51) Int. Cl. G01W 1/10; G06T 11/60

(52) U.S. Cl. CPC G01W 1/10; G06T 11/60

(57) ABSTRACT

A system for and method of generating storm forecasts is provided. The method utilizes de-storm and re-storm processes to avoid washout associated with location divergence. During the de-storm process, storm information is identified in and extracted from a plurality of forecast models, thereby generating a plurality of discrete storm models and a plurality of associated background models. The background models are then blended, and the discrete storm models are weighted, thereby generating a blended background model and a weighted discrete storm model, respectively. During the re-storm process, the weighted discrete storm model is added to the blended background model, thereby generating a forecast representing amplitudes associated with the tropical storm.

### CROSS-REFERENCE TO RELATED APPLICATIONS

This application claims priority pursuant to 35 U.S.C. 119(e) to U.S. Provisional Patent Application Ser. No. 63/524,509, filed Jun. 30, 2023, the entire disclosure of which is incorporated herein by reference.

### FIELD OF THE INVENTION

The present invention relates generally to tropical storm forecasting. More specifically, the present invention is concerned with an objective method for applying deep learning models for deterministic prediction of full spatiotemporal fields of wind, pressure, and rainfall associated with tropical cyclones.

### BACKGROUND

Many existing weather forecast engines are built on a multi-model ensemble blend, with the blend itself involving sophisticated weighting and sophisticated bias correction. Unfortunately, existing blending techniques result in large perturbations in the forecasts being washed out. While presumably satisfactory for certain forecasting purposes, such as a temperature forecast that minimizes root mean square errors, the amplitude of the perturbations is important when forecasts involve extreme events, such as hurricanes, cyclones, typhoons, and the like (each a “tropical storm”). Accordingly, it would be beneficial to have a blending technique that does not wash out large perturbations.

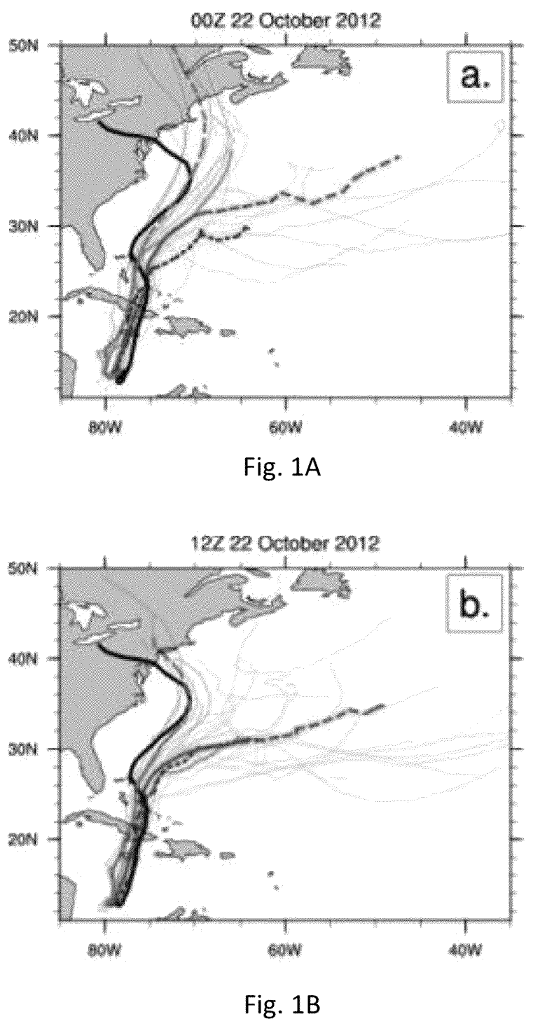

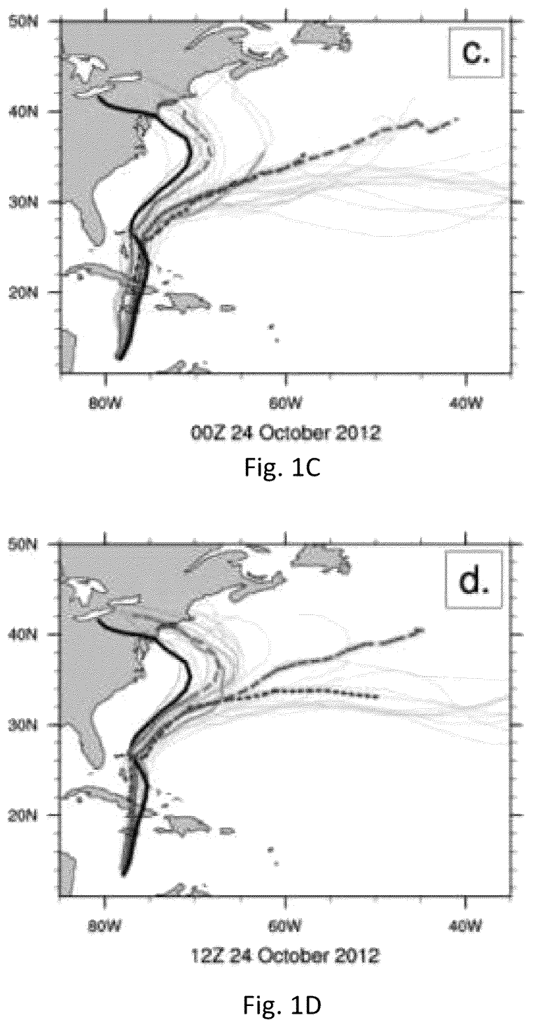

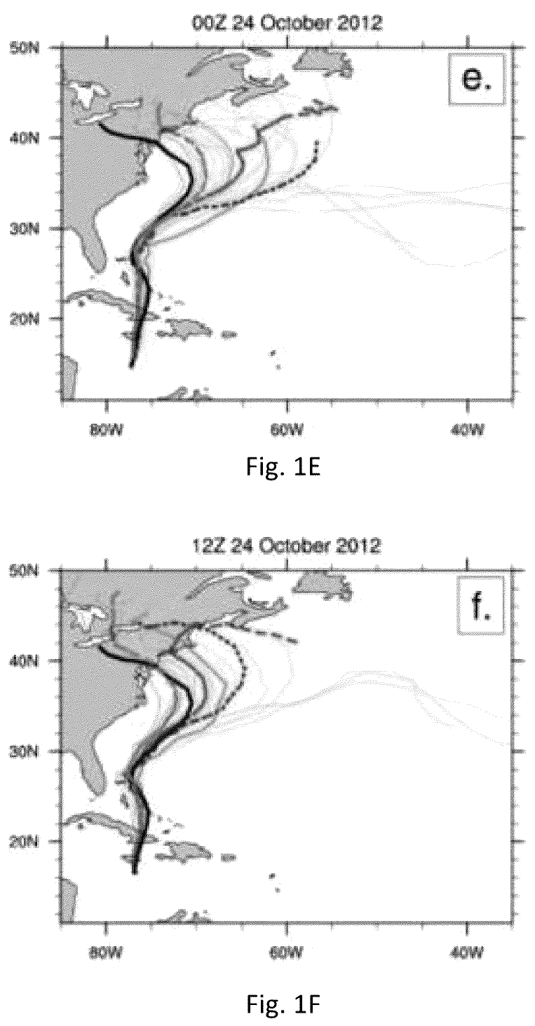

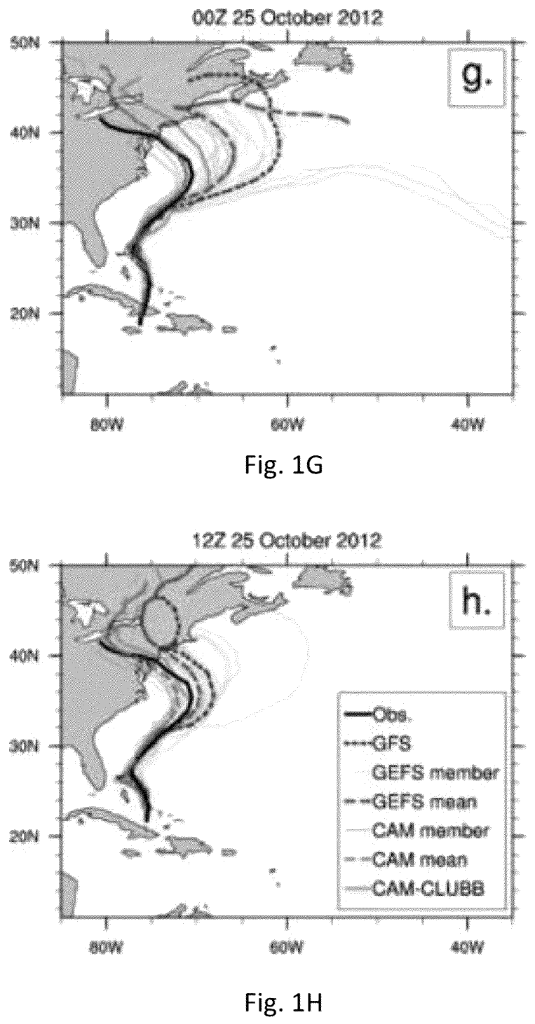

For various existing forecast models, certain important features of each individual tropical storm forecast model diverge spatially over time such that blending leads to blurring, de-amplification, or other distortion (each a “distortion”) of such important features in the final blended tropical storm forecast model. This is especially problematic for situations in which a forecast bifurcates, such as the example multi-model forecast track for Hurricane Sandy shown in FIGS. 1A-1H. Accordingly, it would be beneficial to have a modeling technique that adjusts for spatial divergence to avoid distortion of the modeled tropical storm.

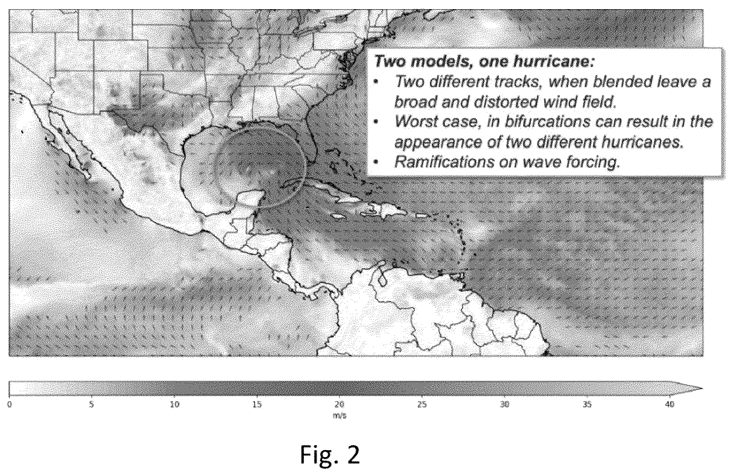

Referring to FIG. 2, an example of a distorted forecast is provided. In particular, FIG. 2 shows a Global Forecast System (“GFS”) forecast model that shows two distinct eyes, one being shifted 200 miles westward from the other. As will be understood, the duplicate eyes are a result of blending two models that differ in their anticipated location and/or track for a particular tropical storm. In addition to showing two distinct eyes, the effect of blending these two modeled storms into a single forecast model is a broadened, weakened, and distorted wind field that does not accurately reflect the modeled wind fields associated with either model. This significant distortion of the wind field in this blend has direct ramifications on forcing in wave models that employ the blended forecast. Accordingly, it would be beneficial to have a modeling technique that eliminates or otherwise reduces distortions to the associated wind fields.

Because spatial divergence of forecast models tends to increase as a forecast period increases, existing blending techniques have limited value for forecasts beyond a few days or hours. But preparations for tropical storms often require notice of the severity and anticipated track of the storm several days in advance. Accordingly, it would be beneficial to have a blending technique that facilitates long-term forecasting for tropical storms.

Existing forecasting systems rely on certain critical information provided by existing software, such as the Automated Tropical Cyclone Forecasting System or the like (each being referred to herein as “ATCF”). Unfortunately, precipitation is not a parameter that is described in any manner in the ATCF. For instance, there is no condensed summary or reduced dimensionality of this parameter assigned to specific tropical storms. As such, precipitation must be extracted from the full grids of forecast model guidance. The challenge is then to identify the tropical storm within those grids. To the extent that existing systems may be capable of extracting precipitation from full grids of forecast model guidance, such extraction is time consuming and unreliable. Accordingly, it would be beneficial to have a system for and method of quickly and reliably obtaining precipitation information for tropical storms.

### SUMMARY

The present invention comprises systems for and methods of blending traditional forecast models. The systems and methods utilize specialized modeling techniques that, when compared with modeling techniques of existing systems, are better suited for forecasting tropical storms. In particular, the blending technique of the present invention does not wash out large perturbations associated with tropical storms.

In some embodiments, the present invention adjusts for spatial divergence, thereby avoiding associated distortions of the modeled tropical storm. In some such embodiments, storm elements are removed from a model prior to a blend, and the storm elements are added back into the model following the blend.

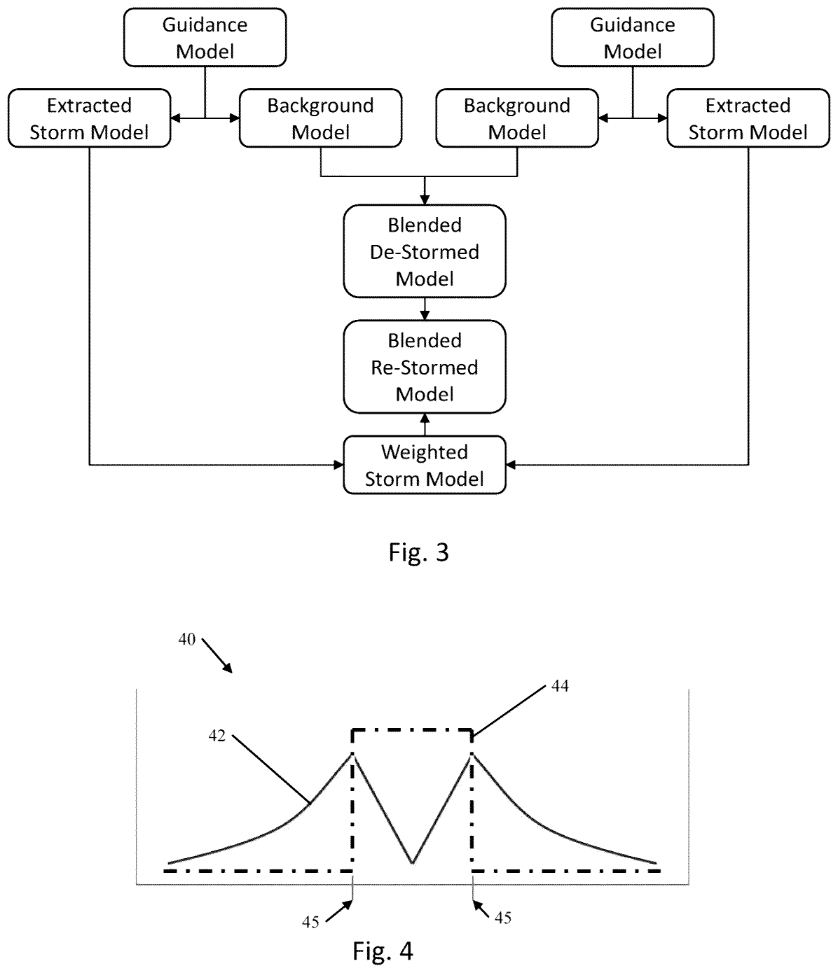

Referring to FIG. 3, a high-level flow chart of an embodiment of the present invention is provided. In the flow chart provided, each of an extracted storm model and a background model is generated for each of two guidance models. The background models are then blended, thereby forming a blended de-stormed model, and the extracted storm models are weighted to generate a weighted storm model. Finally, the weighted storm model is combined with the blended de-stormed model, thereby forming a blended re-stormed model. In this way, the present invention eliminates or otherwise reduces distortions, such as distortions to wind fields.

In some embodiments, the present invention includes systems for and methods of quickly and reliably obtaining precipitation information. In some such embodiments, the present invention utilizes one or more neural networks, such as U-Net or the like, for detecting and processing information. In some embodiments, a neural network is utilized to detect information about specific fields, such as precipitation fields, wind fields, and the like. In some embodiments, the neural network is trained on millions of images of reanalyzed fields, such as by using an objective tropical cyclone database to label the images. The neural network is then used to identify tropical storms in each model that is incorporated into a forecast engine blend, such as a global forecast engine blend. The tropical storms found in each model forecast are extracted, grouped, and weighted according to certain methods of the present invention, such as by comparing the position of each extracted storm relative to a track forecast associated with the present invention. Each extracted storm is then recentered on the track forecast prior to being blended with the other extracted storms. The application of the neural network for producing a deterministic tropical storm forecast provides an unparalleled advantage for both tropical storm impacts and accurate and realistic tropical storms within the forecast engine blend.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

Embodiments of the present invention are described in detail below with reference to the attached drawing figures, wherein:

FIGS. 1A-1H are images of a historical multi-model forecast track.

FIG. 2 is an image of a forecast model that shows two distinct eyes.

FIG. 3 is a high-level flow chart of an embodiment of the present invention.

FIG. 4 is a simplified graphical representation 40 of radial winds and vorticity of a tropical storm.

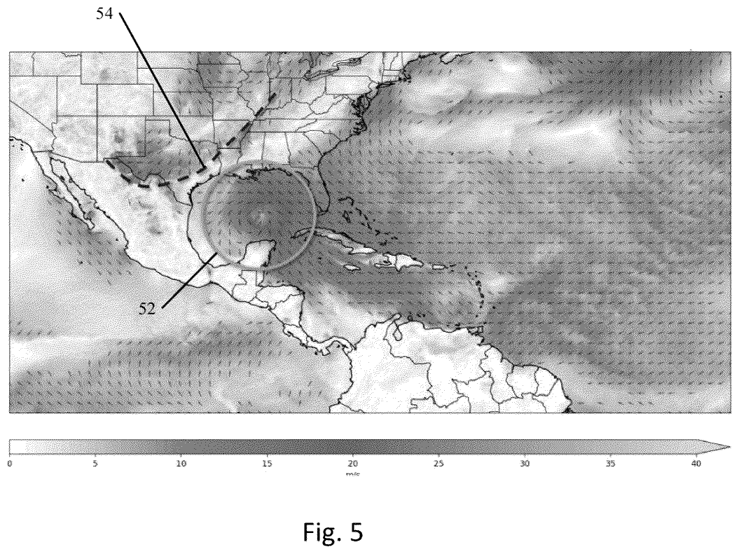

FIG. 5 is an image of a single model forecast showing a modeled wind field.

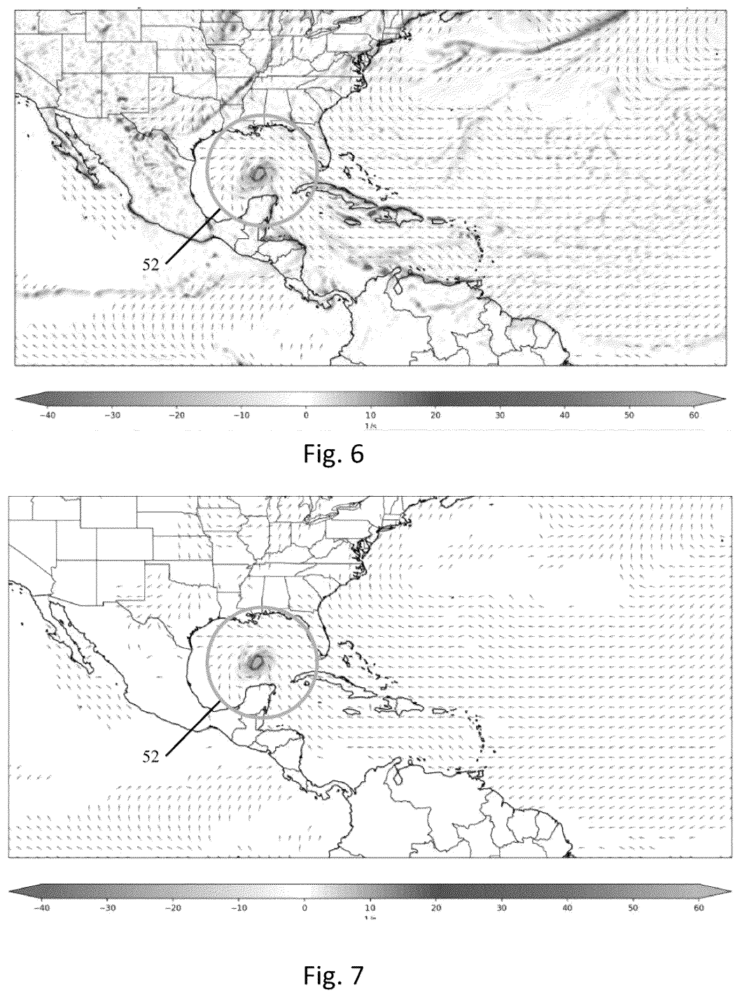

FIG. 6 is an image of the single model forecast of FIG. 5, showing a vorticity field.

FIG. 7 is an image showing the vorticity field of FIG. 6 following application of a window function of the present invention.

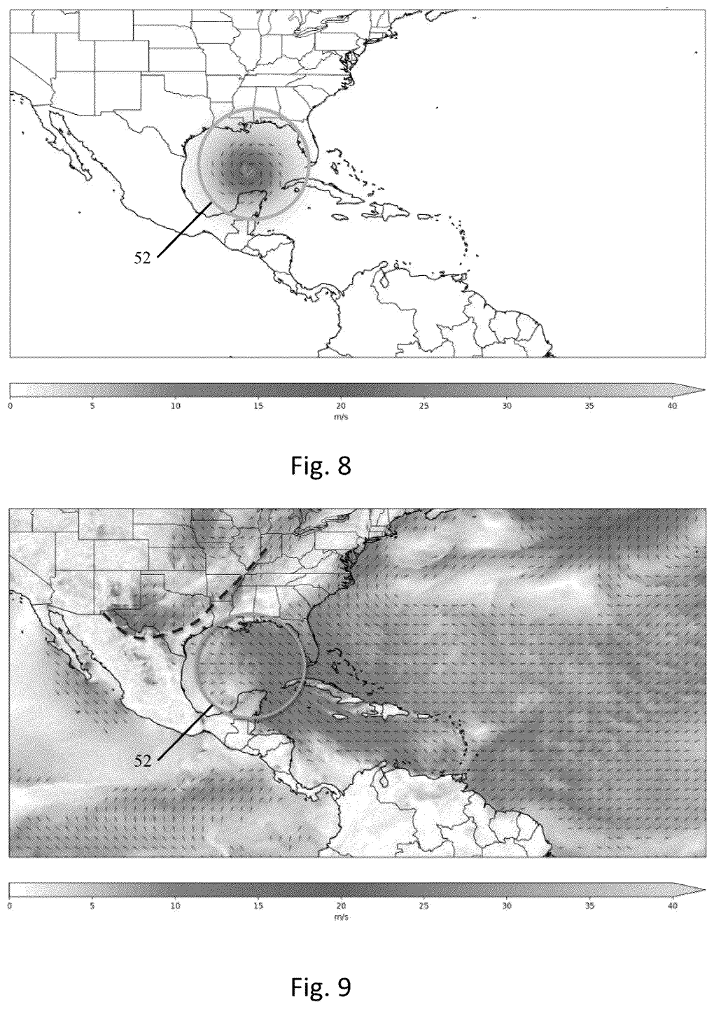

FIG. 8 is an image showing a discrete wind field of a tropical storm.

FIG. 9 is an image showing a background wind field of the present invention.

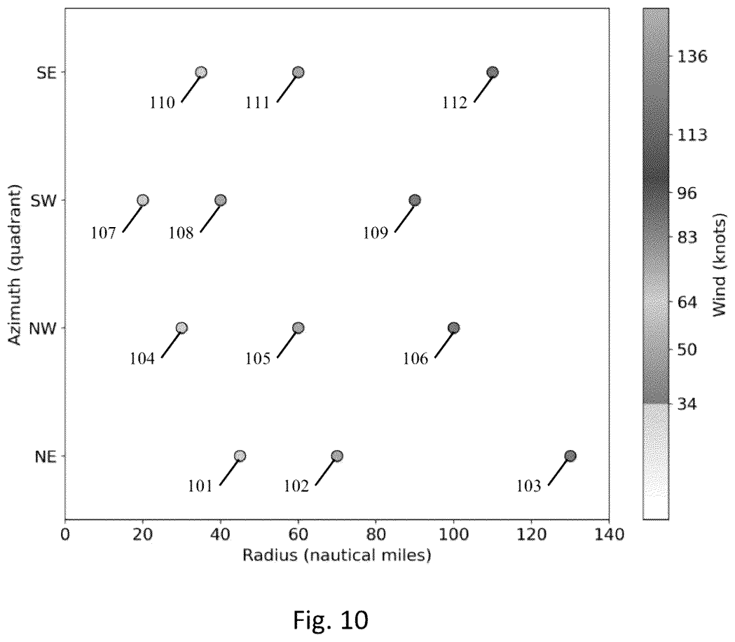

FIG. 10 is an image of a graphical polar representation of wind speeds at three radii for each of four quadrants of a tropical storm.

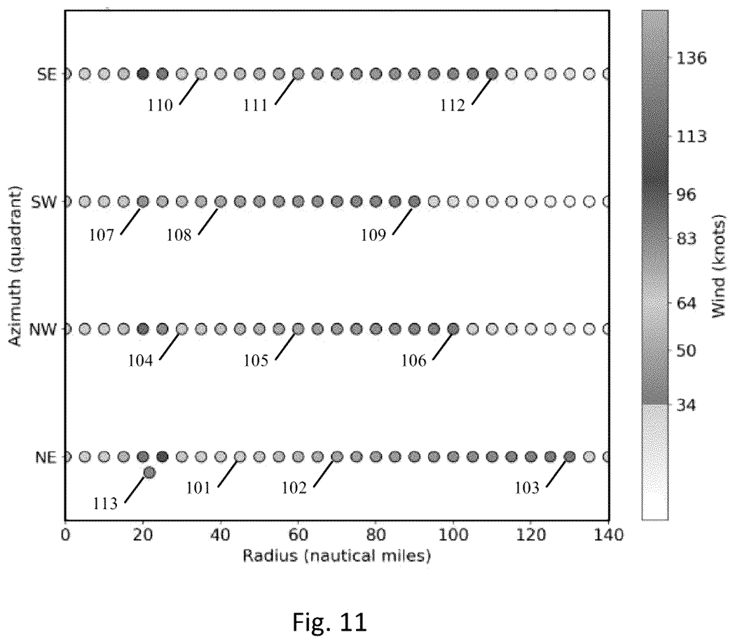

FIG. 11 is an image of a graphical polar representation of wind speeds at various radii for each of four quadrants of a tropical storm.

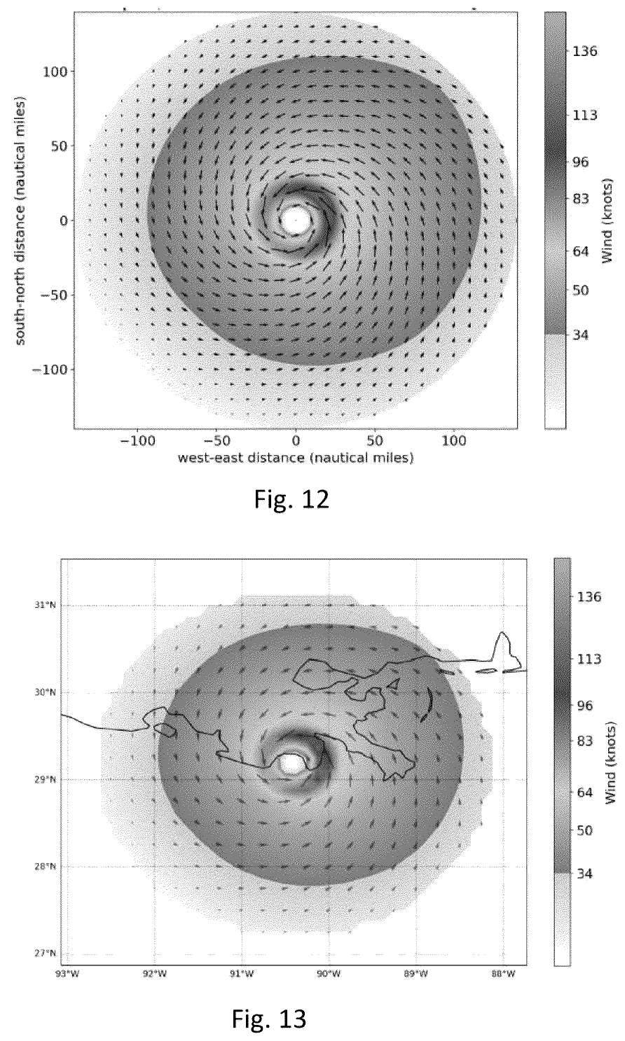

FIG. 12 is an image of a graphical cartesian representation of wind speeds of a tropical storm.

FIG. 13 is an image of the wind speeds of FIG. 12 centered at a latitude and longitude.

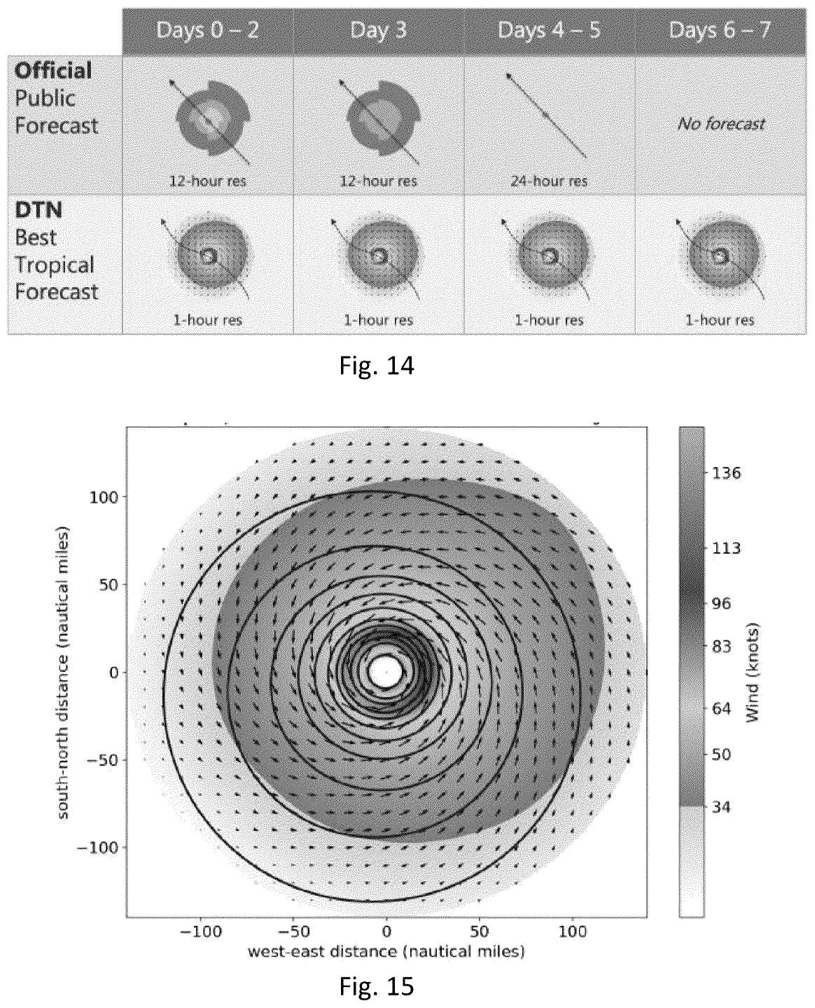

FIG. 14 is an image showing representative forecast capabilities of the present invention in contrast with forecast capabilities of existing public forecasts.

FIG. 15 is an image of a graphical representation of wind speeds and a pressure field.

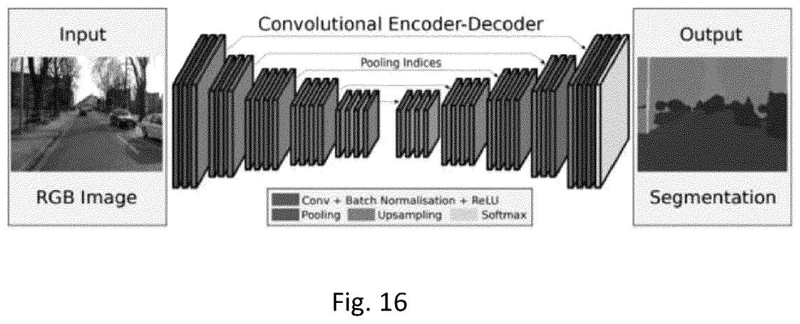

FIG. 16 is an image of a graphical representation of a neural network associated with certain embodiments of the present invention.

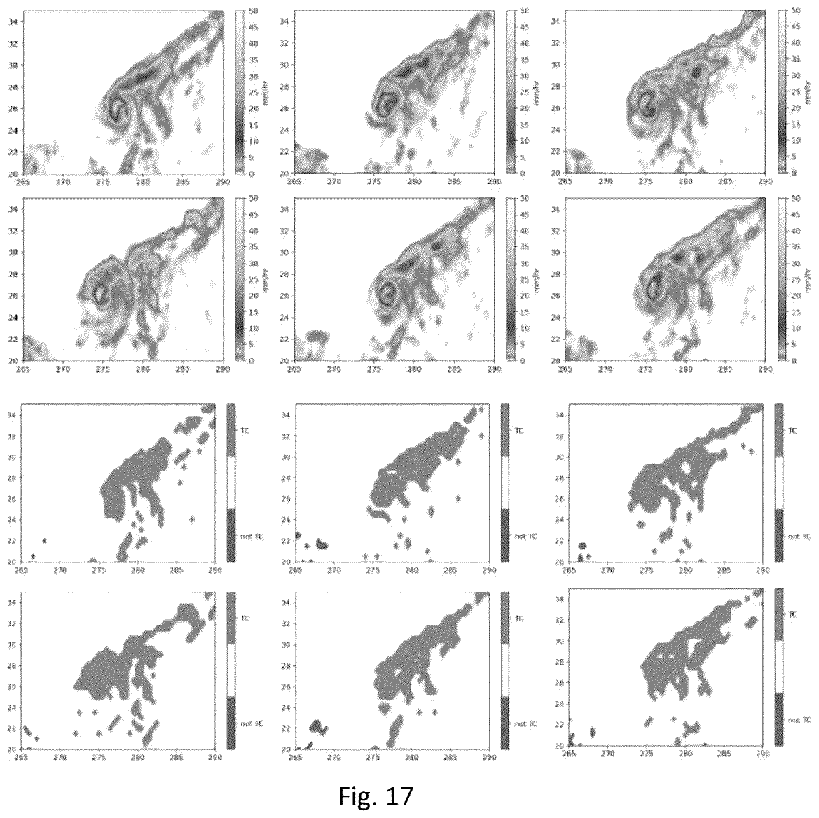

FIG. 17 includes several images, each image including a graphical representation of precipitation rate fields.

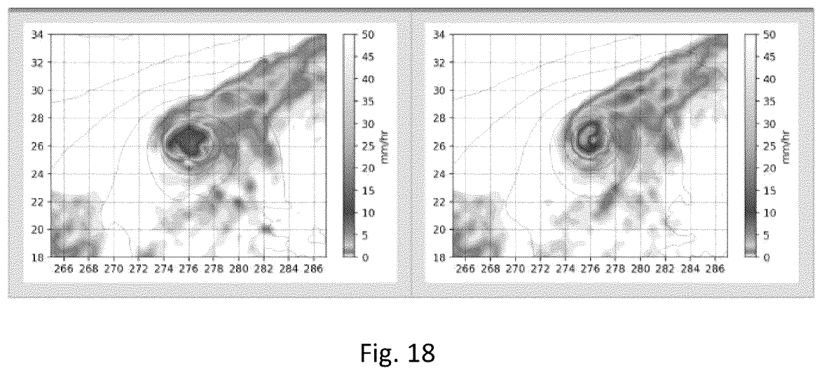

FIG. 18 includes two images, each image including a graphical representation of a tropical storm.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIG. 4, a simplified graphical representation 40 of a tropical storm includes first 42 and second 44 curves representing radial winds and vorticity, respectively. More specifically, the first curve 42 represents wind speeds of radial winds of the tropical storm, which increase linearly from zero at the center (the “eye”) to a maximum value at a given radius (the “eyewall”) 45, and then asymptote back to zero beyond the eyewall 45. The second curve 44 represents vorticity, which is a measure of an amount of spin that horizontal wind shear creates at a given point. As shown in FIG. 4, the second curve 44 is a step function defined by a constant peak value inside the eyewall 45, and a zero value beyond the eyewall 45. Utilizing this basic understanding, a wind model of a tropical storm can be effectively removed from each forecast model (“de-storm”) prior to the forecast models being blended.

De-storm is not simply taking an eraser to model grids. Instead, de-storm leaves behind a physically realistic background wind field. Winds from tropical storms extend radially outward, sometimes for several hundred miles, and are superimposed on the background flow, making it difficult to disentangle the background flow directly from the radial winds of the tropical storm. As described in more detail below, vorticity does not suffer from the same problem.

Referring to FIG. 5, which shows a single model GFS forecast having a modeled wind field, it is observed that the tropical storm influences the portion of the modeled wind field that is positioned within a first region 52. The model also shows a boundary element 54 representing a cold front boundary. Because the boundary element 54 is positioned outside of the first region 52 it is anticipated that the tropical storm will have minimal direct impact on the cold front boundary. Accordingly, the de-storm process removes the influence of the tropical storm on the modeled wind field while leaving the model of the cold front boundary untouched.

Referring to FIG. 6, vorticity calculated from the wind field of FIG. 5 is shown. As can be seen, the vorticity in the first region 52 is tightly concentrated within the core of the modeled tropical storm, thereby facilitating identification of the vorticity associated with the modeled tropical storm. In some embodiments, identifying the vorticity comprises finding a maximum vorticity and applying a cosine-tapered window radially outward. Referring to FIG. 7, this window leaves behind just the vorticity in the proximity of the tropical storm.

Referring to FIG. 8, a discrete wind field for the tropical storm can be determined by converting the vorticity field into a global spectral space. In some such embodiments, converting the vorticity field into a global spectral space comprises integrating in spectral space and then converting back to generate the discrete wind field. Referring to FIG. 9, a background wind field can be determined by subtracting the discrete wind field from the modeled wind field, thereby completing the De-Storm process for the specific model. In some embodiments, the existence of multiple contemporary tropical storms requires the de-storm process to be conducted for each tropical storm, thereby producing a background wind field with each storm being removed. In some such embodiments, each discrete wind field is simultaneously subtracted from the modeled wind field. In other embodiments, one or more intermediate wind fields are generated prior to subtracting a final discrete wind field to obtain the background wind field. In some embodiments, each model is associated with one or more relevant times associated with the tropical storm.

The de-storm process is applied to each of a plurality of models to prepare the same for blending. After blending the de-stormed models, the resultant blended model (the “blended de-stormed model”) is ready for the storm elements to be added back in (“re-storm”). In some embodiments, Re-Storm comprises production of a deterministic tropical storm forecast (a “discrete storm model”) complete with spatiotemporal parameters that can be super-imposed onto the official forecast grids for the blended de-stormed model.

In some embodiments, generation of a discrete storm model begins with reading ATCF model guidance information for a tropical storm, such as information associated with the track, intensity, and size of the tropical storm. Depending on the storm, the volume of the model ensemble can be very large, possibly including up to 120 different models (each a “guidance model”). The track forecast is generated first, using a weighted blend of at least some guidance models of the available ensemble. The weights are pre-seeded using a random forecast deep learning technique that looks at the performance of historical models, such as historical models from the past 5 years of storms. These optimized pre-seeded weights are then updated at each lead-time for a given storm, based on agreement with an official public forecast, such as the National Hurricane Center (“NHC”) or the Joint Typhoon Warning Center (“JTWC”). The weighted model forecast tracks are then blended together for all available timesteps, allowing the storm forecasts of the present invention to extend out for an extended period of time, such as 7 days. This methodology produces a forecast that does not contradict the official public forecast, but adds significantly greater resolution, information, and value to what has been available in a tropical storm forecast up until now.

In some embodiments, the present invention utilizes maximum sustained winds, minimum central pressure, and radii of 34 knot, 50 knot, and 64 knot winds in each of four quadrants of a tropical storm. In some embodiments of the present invention, at least some of this information is utilized to generate an optimal deterministic forecast.

In addition to determining wind fields, as discussed in more detail above, some models of the present invention include full spatial fields of mean sea level pressure and precipitation. In some embodiments, a pressure parameter is important for driving wind and storm surge models. In some such embodiments, the wind and storm surge models are combined with other information, such as wind fields and the like, to create a complete tropical storm forecast package.

The model guidance available in the ATCF messages is conveniently also available in an archive. Accordingly, some embodiments of the present invention utilize a machine learning model, trained on the performance of the forecast models for past tropical storms. In some embodiments, a random forest is trained on 5 years of tropical storms, with all the archived forecast models that are available in the ATCF. In some embodiments, the training is validated using a secondary information source, such as International Best Track Archive for Climate Stewardship (“IBTrACS”). The goal of the random forest is not to make the prediction itself, but rather to pick the forecast model that it anticipates will perform the best for modeling a current tropical storm. Inputs include location and basin of the current tropical storm, speed and direction, and intensity. The results of the random forest are probabilistic on a scale from 0 to 1, which are then used for initial seeding of weights for each forecast model.

In some embodiments, construction of specific fields is accomplished in parallel with removal of tropical storm attributes from each of the models contributing to the forecast engine blend, thereby leaving behind background conditions. While a precipitation field is effectively zero in the shadow of an extracted storm, the wind field can have a significant background component. In some embodiments, a center of a tropical storm is identified through a cyclone-tracking algorithm, and a cosine-tapered window is applied to the 10 m vorticity and divergence fields around the center. That window is then removed, and utilizing a Fourier decomposition, the remaining winds are retrieved through integration. These resulting winds represent the background flow.

In some embodiments, information associated with the extracted storms, such as information associated with specific fields, is superimposed on top of a blended background model, thereby reintroducing the tropical storm. Some embodiments of the present invention are configured to reduce sharp edges in the models. In some embodiments, to prevent sharp edges between a cyclone field and a forecast blend, and to preserve features resulting from extratropical interaction, some vorticity is added back in during the de-storming process. In some such embodiments, the vorticity is added at the cyclone forecast center at the given valid time, is proportional to the amount of vorticity that was removed in the first place, and tapers away from the center. The result is a cyclonic wind field that blends into the background flow behind the tropical cyclone field, as would be expected beyond the outer radius of tropical storm force winds.

In a specific example of the present invention, a first forecast point for a tropical storm is generated using a weighted blend with initial weights. In some such examples, a confirming forecast, such as NHC, JTWC or other government agency and/or public forecast, is then used like an observation in data assimilation. The weights of each forecast model are shifted higher or lower based on how close the model track for the forecast model is to the track for the confirming forecast; rewarding the models that are closer and penalizing the models that are further away. In this way, the forecast of the present invention does not contradict the confirming forecast. In some embodiments, the present invention applies the same weighted blend to the wind radii and higher temporal resolution information provided in the ATCF. This is especially important in situations of rapid intensification and landfall.

Referring to FIG. 10, some embodiments of the present invention utilize wind radii information that is available in four quadrants (northeast, southeast, southwest, northwest) for three thresholds (34, 50, and 64 knots). In some such embodiments, each of these 12 data points (101-112) in total are used to form a complete wind field, beginning with interpolation in polar coordinates.

Referring to FIG. 11, some embodiments of the present invention add thirteenth point 113 to represent a maximum sustained wind. In some embodiments, an azimuth is determined by a sine fit of the highest available wind radii threshold. In some such embodiments, the maximum wind is placed where the wind radii is largest in the sine fit. In some embodiments, the radius of maximum wind is determined by vorticity constraints. In some embodiments, the rest of the interpolated points are ramped up to the maximum wind, using a cosine smoother with a width determined by the amplitude of that initial sine fit.

Referring to FIG. 12, in some embodiments the wind field is next interpolated across a high-resolution grid in polar coordinates, and then converted to cartesian coordinates, with wind direction determined by an implied cyclonic rotation, with a prescribed convergent angle. Referring to FIG. 13, a final step in some embodiments of the present invention includes converting the wind field in cartesian coordinates to a forecast engine grid. Referring to FIG. 13, the tropical storm information can then be centered using latitude and longitude information.

Referring to FIG. 14, some embodiments of the present inventions, such as those embodiments identified as “DTN Best Tropical Forecast” in FIG. 14, provide information that is consistent with confirming forecasts, such as confirming forecasts identified as “Official Public Forecast” in FIG. 14, while adding significant value over the confirming forecasts by providing a track and fully-formed wind field at hourly resolution out to a period of time, such as 7 days, that exceeds a period of time information can be obtained from the confirming forecast.

Some embodiments of the present invention include a full gridded wind field. In some such embodiments, sea level pressure (SLP) is added. SLP can be an important parameter for driving wave and storm surge models. In some embodiments, a SLP forecast is developed using a gradient wind balance approximation to the horizontal force balance in the atmosphere. The gradient wind balance takes the geostrophic wind balance of Coriolis and pressure gradient forces, and sets it equal to the centrifugal force. In some embodiments, such information is an important addition for strongly curved flow, such as that found in a tropical storm. Solving for the pressure gradient force, or geopotential gradient, we get:

$$\frac{{V}^{2}}{R} + fV = - \frac{\partial ∅}{\partial n} \qquad ( Equation 1 )$$

In Equation 1, V is the wind velocity, R is the radius of the wind, f is the Coriolis parameter, and the right side of Equation 1 is the geopotential gradient to the right of the wind. In the case of circular flow, the right side simplifies to a radial gradient. Integrating Equation 1 with respect to R, and setting the reference constant (where R=0) equal to the minimum central pressure (which is an output forecast parameter from several models in the ATCF), a full pressure field in polar coordinates is retrieved. Referring to FIG. 15, the information is converted to cartesian coordinates and then added to the forecast engine grid.

In some embodiments, the present invention utilizes a machine learning approach for obtaining information, such as precipitation information. In some such embodiments, the machine learning approach utilizes a neural network, such as a U-net having an encoder network followed by a decoder network. Referring to FIG. 16, the encoder uses a series of convolutional neural networks and pooling to down-sample in order to identify features in an input array. The decoder uses transposed convolutional networks with up-sampling, in order to identify where those features are present in the input. The result is an array with the same size as the input, containing probabilities of classifications at each pixel, or grid cell. This result is referred to as semantic segmentation, which provides a high level of granularity for understanding an image. Preceding levels include classification, in which an object in the image is identified, localization, in which a box is drawn around that object, and detection, in which multiple objects in the image are localized. In some embodiments, the neural network requires very few annotated images. In some embodiments, data augmentation with elastic transformations is used to drastically increase the training sample size. In some embodiments, each pixel associated with a tropical storm is labeled.

In some embodiments, the neural network is trained with extensive background information, such as by training on five years of reanalysis one-hour precipitation rate images in a 15-degree by 15-degree box, all remapped to the forecast engine grid resolution, with 30% of the images containing tropical storms, and 70% of the images used as a null sample. In some embodiments, the tropical storms used in training are identified using the IBTrACS database. Referring to FIG. 17, a specific example utilizes a depth of 6 layers, 37 epochs, and a focal loss function. In the example represented by FIG. 17, six different precipitation forecasts are ingested by a neural network and an output segmentation array is returned with labels for TC and no-TC.

Still referring to FIG. 17, which shows one-hour precipitation rate fields associated with a tropical storm, a sophisticated blending technique can be used to produce a deterministic precipitation forecast for the tropical storm. First, weights are assigned to each model, as determined by the distance between an extracted storm center, and a confirming forecast storm model center at the same valid time. The closer these forecast centers are together, the more weight the model is given. More specifically, weights have a reverse exponential relationship with the distance between centers. In some embodiments, a tropical cyclone precipitation shield can look substantially different from model to model depending on proximity to extratropical features like frontal boundary, or the jet stream, and this weighting technique helps ensure that the resultant precipitation image is also consistent with the track. In some embodiments, new weights are calculated at each valid time.

In some embodiments, precipitation images from each model are recentered on the storm center. In some such embodiments, each grid point that is labeled a tropical storm is repositioned relative to the extracted storm center based on its location relative to the confirming forecast storm model center. Finally, the weighted and recentered images are blended together for the official precipitation forecast. Referring to FIG. 18, the present invention facilitates retention of amplitude and other features of a tropical storm (represented by the right side of FIG. 18) that is superior to blends available using prior art systems and methods (represented by the left side of FIG. 18).

Various embodiments of the present invention utilize, encompass, or are facilitated by computer programs, devices, systems, methods, and the like. Various embodiments of computer programs, devices, systems, and methods are implemented in hardware, software, firmware, or combinations thereof, such as by using a central management system (e.g. TCS or other central computer control system), which broadly comprises server devices, computing devices, a communications network, and the like. Various embodiments of the server devices include computing devices that provide access to one or more general computing resources, such as Internet services, electronic mail services, data transfer services, and the like. In some embodiments the server devices also provide access to a database that stores information and data, with such information and data including, without limitation, system user information (e.g. project ID, account number, etc.), or the like, or other information and data necessary and/or desirable for the implementation of the computer program, devices, systems, and methods of the present invention.

Various embodiments of server devices and computing devices include any device, component, or equipment with a processing element and associated memory elements. In some embodiments the processing element implements operating systems, and in some such embodiments is capable of executing a computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos, bar codes or other identification information.

In some embodiments a computing device includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses, or the like. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of computer programs associated with present invention run on computing devices. In other embodiments an associated computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on a memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using a computer program will actually be performed by one or more computers, processors, or other computational devices, such as the computing devices and/or server devices, independently or cooperatively executing portions of the computer program.

Various embodiments of the present invention are accessible via an electronic resource, such as an application, a mobile “app,” or a website. In certain embodiments, portions of a computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of blending a plurality of forecast models, the method comprising:
generating a plurality of discrete storm models, each discrete storm model being generated from a respective forecast model of the plurality of forecast models;
extracting each discrete storm model from its respective forecast model, thereby generating a background model for each forecast model;
blending the background models, thereby generating a blended background model; and
adding a weighted storm model to the blended background model, the weighted storm model being generated using information from at least one discrete storm model of the plurality of discrete storm models.

2. The method of claim 1, wherein each forecast model comprises a modeled wind field, each discrete storm model comprises a discrete wind field, and each background model comprises a background wind field that is determined by subtracting the discrete wind field from the modeled wind field.

3. The method of claim 2, wherein generating each discrete storm model comprises:
calculating vorticity for the modeled wind field;
finding a maximum vorticity associated with a first tropical storm;
applying a cosine-tapered window radially outward from the maximum vorticity, thereby isolating vorticity in the vicinity of the tropical storm from any other potential vorticity associated with the respective modeled wind field; and
converting the isolated vorticity into a global spectral space.

4. The method of claim 3, further comprising:
identifying a geographic center for each extracted discrete storm, thereby identifying an extraction center for each background model; and
adding a respective first amount of vorticity to each background model, the added vorticity being centered around the respective extraction center for each background model,
wherein each first amount of vorticity is proportional to vorticity of its respective extracted discrete storm model, and
wherein the added vorticity for each background model tapers away from the respective extraction center.

5. The method of claim 3, further comprising generating the weighted storm model using information from each of the plurality of discrete storm models, values for each discrete storm model being organized based on a position of each value relative to a center of the respective discrete storm model, and a weight for each discrete storm model being determined based on a distance of the center of the respective discrete storm model from a center of the weighted storm model.

6. The method of claim 5, wherein the weight of each discrete storm model is determined using a reverse exponential relationship with the distance of the center of the respective discrete storm model from the center of the weighted storm model.

7. The method of claim 6, wherein the weight is one for each discrete storm model that is concentric with the weighted storm model.

8. The method of claim 7, wherein the center of the weighted storm model is determined using information from a confirming forecast storm model.

9. The method of claim 8, further comprising utilizing a neural network to identify storm information for each forecast model, wherein extracting each discrete storm model from its respective forecast model comprises extracting the identified storm information from each forecast model.

10. The method of claim 9, wherein the identified storm information is precipitation information.

11. The method of claim 1, further comprising utilizing a neural network to identify storm information for each forecast model, wherein extracting each discrete storm model from its respective forecast model comprises extracting the identified storm information from each forecast model, and wherein the identified storm information is precipitation information.

12. A method for generating a forecast for a tropical storm, the method comprising:
utilizing a neural network to identify storm information for each guidance model of a plurality of guidance models;
extracting the storm information from each guidance model, thereby generating a background model for each guidance model;
processing the background models to generate a blended background model; and
adding weighted storm information to a first region of the blended background model.

13. The method of claim 12, wherein the storm information comprises at least one of precipitation information, storm surge information, and wind information.

14. The method of claim 13, wherein the storm information comprises precipitation information, and wherein precipitation is effectively zero in the first region of the blended background model prior to adding the weighted storm information to the blended background model.

15. The method of claim 14, wherein the storm information comprises storm surge information, and wherein storm surge information is effectively zero in the first region of the blended background model prior to adding the weighted storm information to the blended background model.

16. The method of claim 15, wherein the storm information comprises wind information, and wherein wind information is not equal to zero in the first region of the blended background model prior to adding the weighted storm information to the blended background model.

17. A system for generating a forecast for a tropical storm, the system comprising:
a de-storm module for identifying and extracting storm information from a plurality of forecast models, thereby generating a plurality of background models;
a blending module for blending the background models, thereby generating a blended background model; and
a re-storm module for adding a weighted storm model to the blended background model.

18. The system of claim 17, further comprising a weighting module for generating the weighted storm model using information from each of the plurality of discrete storm models, values for each discrete storm model being organized based on a position of each value relative to a center of the respective discrete storm model, and a weight for each discrete storm model being determined based on a distance of the center of the respective discrete storm model from a center of the weighted storm model.

19. The system of claim 18, wherein the weight of each discrete storm model is determined using a reverse exponential relationship with the distance of the center of the respective discrete storm model from the center of the weighted storm model.

20. The system of claim 19, wherein the weight is one for each discrete storm model that is concentric with the weighted storm model.
